(19) United States
(12) Patent Application Publication
(10) Pub. No.: US 2007/0073791 A1
(43) Pub. Date: Mar. 29, 2007

(54) Centralized management of disparate multi-platform media

(75) Inventors: Timothy R. Bruce, Carrollton, TX (US); John M. Casey, Carrollton, TX (US); William R. Evans, Coppell, TX (US)

Correspondence Address: BAKER BOTTS L.L.P., 2001 ROSS AVENUE, SUITE 600, DALLAS, TX, 75201-2980, US

(73) Assignee: Computer Associates Think, Inc.

(21) Appl. No.: 11/263,224

(22) Filed: Oct. 31, 2005

Related U.S. Application Data
(60) Provisional application No. 60/721,379, filed on Sep. 27, 2005.

(51) Int. Cl. G06F 17/30

(52) U.S. Cl. 707/204

(57) ABSTRACT

According to a particular embodiment of the present invention, a method for managing backup information is provided. The method includes collecting backup information from a plurality of backup products. The backup information collected from the plurality of backup products is converted into a common format. The collected backup information is stored in a centralized catalog, and access to the backup information stored in the centralized catalog is provided.

### RELATED APPLICATION

This application claims priority under 35 U.S.C. §119 of provisional application Ser. No. 60/721,379, filed Sep. 27, 2005.

### TECHNICAL FIELD OF THE INVENTION

The present disclosure relates to media and, more specifically, to centralized management of disparate, multi-platform tape media.

### BACKGROUND

As the quantity and value of data stored by enterprises continues to grow, it is becoming increasingly important that data is backed up in a secure manner that allows for easy retrieval should it be necessary. As a preferred medium, enterprises may use removable storage such as magnetic tapes and optical disks for storing backup data since such media are typically inexpensive. During the performance of backup processes, multiple tapes and/or disks may be used to store a single backup. Additionally, multiple backups may be made of the same data. For this reason, data may be backed up to multiple units of removable media known as volumes.

In a large enterprise where user data may be stored on diverse systems, multiple backup technologies may be employed. It may therefore be very difficult for users to track and manage backups of their own data. Some backup technologies maintain catalogs that automatically record onto each volume of removable media, key characteristics about data that is backed up. However, users whose data is spread over a large computer network may find it difficult to keep track of and/or manage backups of their data.

Some tape management systems allow the manual entry of data about tapes created on systems that are not part of the tape management environment. For example, a user may manually enter data describing a tape created on a distributed system in a mainframe tape management system. Although this may allow for centralized reporting and management of all tapes in an enterprise, it still requires manual entry of the data. Accordingly, such a system is strewn with shortfalls and can be a burden to maintain.

### SUMMARY OF THE INVENTION

According to a particular embodiment of the present invention, a method for managing backup information is provided. The method includes collecting backup information from a plurality of backup products. The backup information collected from the plurality of backup products is converted into a common format. The collected backup information is stored in a centralized catalog, and access to the backup information stored in the centralized catalog is provided.

Embodiments of the invention provide various technical advantages. One advantage may be that a centralized system of management of storage resources may be provided. The centralized system may be provided with or otherwise acquire backup data from disparate backup products. In particular embodiments, the backup data may include recorded media such as backup tapes. An aggregated collection of the data may be stored in a centralized catalog or other database. Where the aggregated data is received from backup products using different platforms, a further advantage may be that the centralized system may convert the received backup data into a common format. As a result, the data may be more efficiently stored and more readily compared during the performance of monitoring, analyzing, reporting, trending, forecasting, scheduling, and other resource management functions. Such a system may also provide automated networking of storage resources for storage capacity planning, management of storage performance, and reduced cost storage.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and the advantages thereof, reference is now made to the following descriptions taken in conjunction with the accompanying drawings in which:

FIG. 1 is a block diagram illustrating a distributed system for the management of backup information in accordance with an embodiment of the present invention;

FIG. 2 is a block diagram illustrating an example computer system in accordance with an embodiment of the present invention;

FIG. 3 is a block diagram illustrating a distributed system for the centralized management of backup information in accordance with an embodiment of the present invention;

FIG. 4 is a flow chart illustrating an example method for managing backup information in accordance with an embodiment of the present invention; and

FIG. 5 is a block diagram illustrating a distributed system for the centralized management of backup information in accordance with another embodiment of the present invention.

### DETAILED DESCRIPTION OF THE INVENTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present disclosure may provide for the centralized management of backup data volumes across a distributed system and/or a computer network. In particular embodiments, the centralized system may receive backup information from multiple applications that are concurrently run on computers or other network devices in a computer network. The backup information may include backup media tapes that may be acquired using a push or pull method. According to the pull method, the centralized system may request the backup data from the reporting network components at scheduled intervals. Using a push method, the centralized system may receive the backup information from the reporting network components when data is changed or when an update is scheduled. Where the aggregated data is received from backup products using different platforms, the centralized system may convert the received backup data into a common format. As a result, the data may be more efficiently stored and more readily compared during the performance of monitoring, analyzing, reporting, trending, forecasting, scheduling, and other resource management functions.

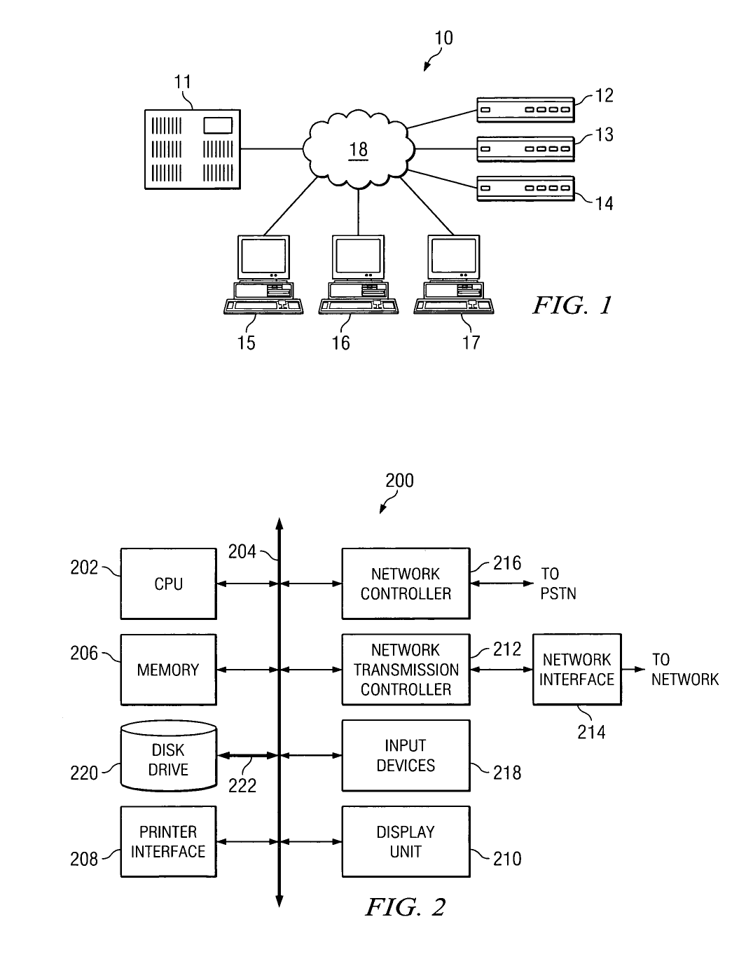

FIG. 1 is a block diagram showing one example configuration of a distributed system 10. In the illustrated embodiment, the distributed system includes a mainframe computer 11, servers 12-14, and workstations 15-17 interconnected by a computer network 18. Various types and combinations of connections may allow mainframe 11, servers 12-14, and workstations 15-17 to share data within distributed system 10. For example, in particular embodiments, the connections between the many devices may include wired connections. In other embodiments, the connections may include wireless connections or some combination of wired and wireless connections.

For providing communication between the components of distributed system 10, network 18 is provided. In particular embodiments, network 18 may include the Internet. Network 18 may include, however, a Land Area Network (LAN), a Wide Area Network (WAN), a Metropolitan Area Network (MAN), a Personal Area Network (PAN), an Intranet, an Extranet, or any combination of these or other suitable communication networks. In fact, any network suitable for allowing the communication of data to, from, and between mainframe 11, servers 12-14, workstations 15-17, and other devices within distributed system 10 may be used without departing from the scope of the invention.

As shown, workstations 15-17 include computer systems. The computer systems may include backup products that operate to acquire backup information related to the data maintained by and used by workstations 15-17. As will be described in more detail below, the backup information may be provided to a centralized application which may aggregate the backup information acquired by and maintained by the multiple workstations 15-17 and store the backup information in a centralized database.

FIG. 2 shows an example of a computer system 200 in accordance with an embodiment of the present disclosure. Computer system 200 may be adapted to execute any of the well known MS-DOS, PC-DOS, OS2, UNIX, MAC-OS, and Windows operating systems or any other suitable operating system. In the illustrated embodiment, computer system 200 includes a central processing unit (CPU) 202 coupled to other system components via an internal bus 204. For example, in the illustrated embodiment, CPU 202 is coupled to a random access memory (RAM) 206, a printer interface 208, a display unit 210, a network transmission controller 212, a network interface 214, a network controller 216, and one or more input/output devices 218 such as, for example, a keyboard or a mouse. As shown, computer system 200 may be connected to a data storage device, for example, a disk drive 220, via a link 222. Disk drive 220 may also include a network disk housed in a server within computer system 200. Programs stored in memory 206, disk drive 220, and/or a ROM (not illustrated) may be executed by CPU 202 for performance of any of the operations described herein.

The illustrated computer system 200 provides merely one example, however, of a computer system that may operate to obtain and manage backup information using disparate backup products within distributed system 10. It is recognized that computer system 200 may include fewer or more components as is appropriate for backup product operations. In particular embodiments, the functions of computer system 200 may be implemented in the form of a software application running on computer system 200, a mainframe, a personal computer (PC), a handheld computer, a server, or other computer system. Where implemented using a software application, the software application may be stored on a recording media locally accessible by computer system 200 and accessible via a hard wired or wireless connection to a network, for example, a LAN, or the Internet.

Returning to FIG. 1, various servers 12-14 and workstations 15-17 within the distributed system may include data backup systems for obtaining and maintaining backup data. For example, each data backup system may operate to acquire backup information of data stored or associated with that device. As a result, a great deal of backup data (and in some instances a great deal of redundant backup data) may be stored within the distributed system. Accordingly, a centralized management system for maintaining backup data from the various data storage devices throughout the distributed system may be useful. Specifically, a centralized management system may allow for localized management of backup data associated with a large number of devices spread out over a large area within the distributed system.

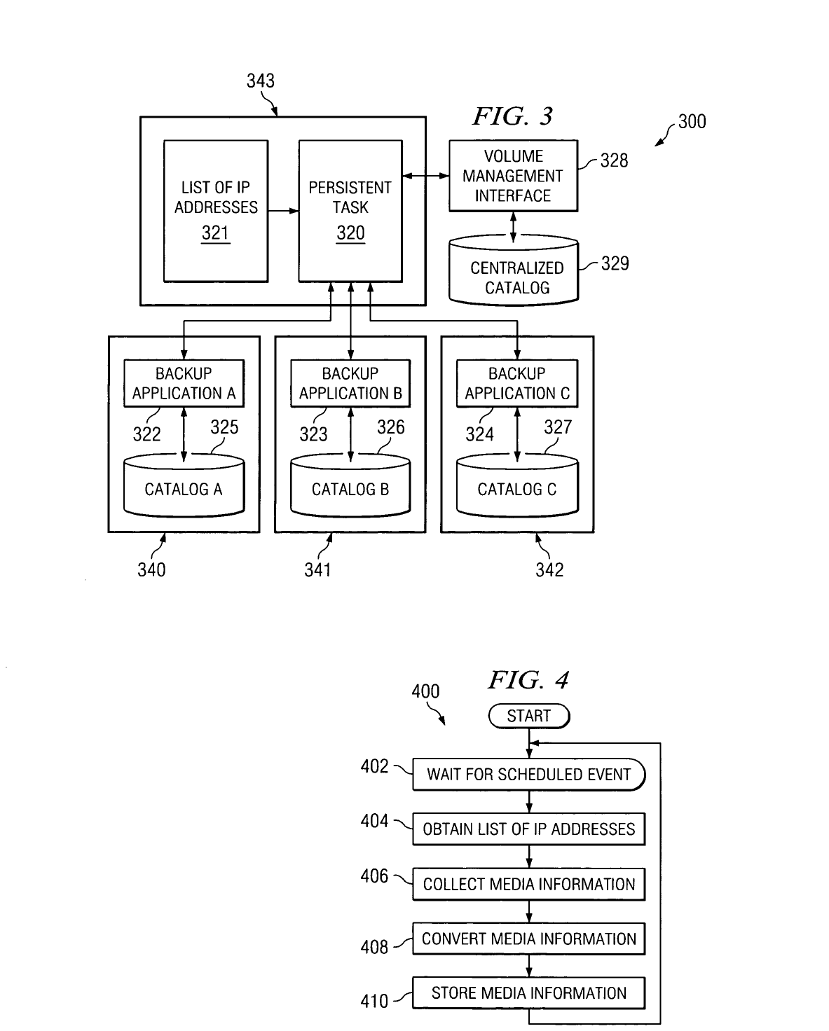

FIG. 3 is a block diagram showing a distributed system 300 for the centralized management of backup volumes according to an embodiment of the present disclosure. As shown, distributed systems and computer networks may have multiple distributed backup applications or other products 322-324 for obtaining and maintaining backup data within distributed data storage devices 340-342. Each backup product 322-324 may have its own catalog 325-327 describing the volumes that it has written. Descriptions of the backup media itself may be stored in the volumes and/or catalogs as well.

Information from the backup product catalogs 325-327 pertaining to the backup volumes along with descriptions of the backup media (collectively referred to as media information) may be extracted and collected by a task (referred to herein as persistent task 320). Persistent task 320 may be an application that is executed on a mainframe or other centralized system. In the illustrated example, persistent task 320 is located on a mainframe 343, which may run IBM's z/OS operating system, in particular embodiments. Persistent task 320 may be incorporated into a storage resource management application such as, for example, a storage resource manager running on mainframe 343.

Persistent task 320 may utilize a list of IP addresses 321 identifying where each backup product 322-324 is executed in order to gather the media information from each of the devices 340-342. Persistent task 320 then stores the media information in a centralized catalog 329. Centralized catalog 329 may be, for example, a repository that is part of mainframe 343 (e.g., a mainframe tape management repository) or may be located on a separate system. Centralized catalog 329 may interface with a volume management interface 328. For example, the media information may be stored in centralized catalog 329 via volume management interface 328.

Persistent task 320 may utilize a push or a pull method to gather media information from backup products 322-324. According to the push method, when changes are made to the media information (for example, when one of the backup product catalogs 325-327 are updated), the changes are automatically sent to persistent task 320. The collected information may then be used to update centralized catalog 329. In contrast, the pull method results in the automatic polling and retrieval of media information from backup product catalogs 325-327 by persistent task 320. As a result of these polling events, persistent task 320 periodically updates centralized catalog 329 to include updated media information.

FIG. 4 is a flow chart showing an example method 400 for managing backup information in accordance with an embodiment of the present disclosure. In the illustrated embodiment, the method is performed by persistent task 320 using a pull method for obtaining updated media information. Accordingly, method 400 begins at step 402 when persistent task 320 waits for the occurrence of a scheduled event. The scheduled event may occur at any interval appropriate for obtaining backup information from disparate backup products within distributed system 300. For example, persistent task 320 may update centralized catalog 329 on a daily basis. Thus, the scheduled event may occur once a day in a particular embodiment.

Once the scheduled time period has occurred, persistent task 320 reads a list of IP addresses 321 associated with backup products 322-324 at step 404. At step 406, persistent task 320 uses the list of IP addresses 321 to collect media information from the associated backup products 322-324. For example, persistent task 320 may poll backup products 322-324 identified by the list of IP addresses 321. The polling may be accomplished, for example, by generating a request for the media information and transmitting a copy of the request to each IP address in the list of IP addresses 321. In particular embodiments, the request may include an XML request that may be sent to each backup product 322-324. In response to the request, the polled backup products 322-324 may provide media information to persistent task 320.

Although common to a single distributed system 300, backup products 322-324 may operate on different platforms. As a result, data associated with backup product 322 may be received by persistent task 320 in a format that is different from the format of data stored in backup products 323 and 324. For the more efficient storage and usage of the media information, persistent task 320 converts the received media information to a suitable uniform format at step 408. As just one example, a backup product 322 may use a standard “C” format for storing time and date information associated with a particular backup operation. The standard “C” format is a time formatting system utilized by the ANSI “C” programming language and is recognized by Unix operating systems. In general, standard “C” programming formats a time stamp as the number of seconds since midnight Jan. 1, 1970.

This format, however, may be different from or incompatible with time stamp systems used by backup products 323 and 324. For example, one or both of backup products 323 and 324 may use a Greenwich-Mean formatting system for time stamps associated with backup data. Unless the time stamps associated with the backup information obtained from disparate and multi-platform backup products are converted to a common format, any centralized storage of the collected backup information may be inefficient. Furthermore, aggregation and analysis of the stored data may be impracticable where different formats are present. Accordingly, in particular embodiments, persistent task 320 may merge the multiple platforms into a common format at step 408. For example, all time stamps associated with backup information may be converted to the standard “C” format. Alternatively, all time stamps associated with backup information may be converted to a Greenwich-Mean formatting system. Regardless of the type of common formatting system used, the converted media information may be stored in centralized catalog 329 at step 410.

As noted above, the backup products may be, for example, executed on one or more remote computer systems and may handle the backing up of a connected data storage device (a backup system). Persistent task 320 may build an internal table to manage subsequent communication with each backup product 322-324. The list of IP addresses where each backup product is executed may be manually supplied to persistent task 320. In the alternative, the list may be automatically generated, for example using an automatic discovery service which automatically finds the backup products on the network and/or distributed system. Thus, persistent task 20 may be provided with or generate the list of IP addresses that is used to collect media information in a system utilizing a pull method.

Modifications, additions, or omissions may be made to the method without departing from the scope of the invention. The method may include more, fewer, or other steps. Additionally, steps may be performed in any suitable order without departing from the scope of the invention. As one possible modification, where backup products 322-324 use a push method to provide backup information to persistent task 320, steps 402 and 404 of the above-described method may be omitted. The collection of media information may include the receipt of backup information that is pushed from the backup products 322-324 to persistent task 320. In such embodiments, a list of IP addresses or discovery tool may also be unnecessary for the collection of media information.

Furthermore, although the conversion performed at step 408 is described above as being related to the conversion of time stamp information, it is recognized that the described conversion is merely one example of a type of conversion that may be performed at step 408. Thus, the conversion performed at step 408 may include the reformatting of any type of data within the collected backup information using any common format recognized by persistent task 320.

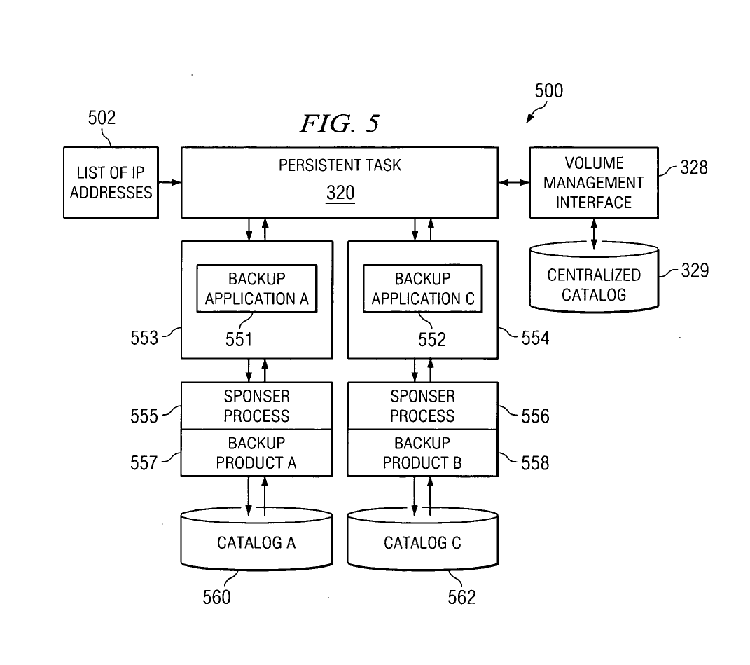

FIG. 5 depicts a block diagram showing a system 500 for centralized management of backup volumes according to another embodiment of the present disclosure. According to this embodiment, an IP address list 502 may include IP addresses of intermediate processes (e.g., gateway processes 551, 552) that interact with the backup products. For example, IP address list 502 may include the IP addresses of gateway processes 551 and 552 that interact with backup products maintained on servers 553 and 554, respectively. The system of FIG. 5 may be used, in particular embodiments, to perform steps similar to those described above with regard to FIG. 4. Thus, persistent task 320 may operate to collect data from intermediary processes 551 and 552 using steps similar to those described above. For example, persistent task 320 may send XML requests via TCP/IP or another communication protocol to intermediary processes 551 and 552 operating on servers 553 and 554, respectively.

In response, gateway processes 551 and 552 may inspect the XML to identify the sponsor processes capable of handling the overall XML request. Gateway processes 551 and 552 may then invoke a process (referred to herein as sponsor processes 555 and 556, respectively) provided with backup products 557 and 558, respectively. The sponsor processes 555 and 556 may interpret the XML request and read their respective backup product catalogs 560 and 562 and collect tape media records or other backup information that has been updated since the last time a request was processed from persistent task 320.

Each sponsor process 555 and 556 may then format a response to the request using the tape media records or other backup information. The response may include the updated backup information identified above and may be transmitted either directly or via gateway process 551 and 552 to persistent task 320. Using a method similar to that described above, persistent task 320 may receive the response and convert the data from the initial format into a common format. The converted information may then be stored in centralized catalog 329.

As noted above, the collected backup information may be communicated using a platform independent format, such as XML. It is recognized, however, that the returned information may be in any format appropriate for transmitting backup data. Where the returned information is communicated in XML or another platform independent format, it may be useful to convert the media information into a format that can more easily be handled by the centralized system. For example, the XML data may be converted into update transactions/initial entries for centralized catalog 329. This conversion may be performed by persistent task 320, in particular embodiments. After the data is converted, the updated backup information may be applied to centralized catalog 329.

During the collection and conversion of the updated backup information, errors may be detected by persistent task 320. Persistent task 320 may handle detected errors by logging error conditions in a log that may be output by persistent task 320. After the media information is stored in centralized catalog 329, users may access the media information (for example, media information relating to their backup data). For example, users may interact with the volume management interface 328 to obtain the desired media information and may track and/or manage the media information as desired. The information collected in the centralized catalog 329 may also be used for centralized reporting of the status of backup volumes throughout the distributed system and/or the computer network.

Embodiments of the invention provide various technical advantages. One advantage may be that a centralized system of management of storage resources may be provided. The centralized system may be provided with or otherwise acquire backup data from disparate backup products. In particular embodiments, the backup data may include recorded media such as backup tapes. An aggregated collection of the data may be stored in a centralized catalog or other database. Where the aggregated data is received from backup products using different platforms, a further advantage may be that the centralized system may convert the received backup data into a common format. As a result, the data may be more efficiently stored and more readily compared during the performance of monitoring, analyzing, reporting, trending, forecasting, scheduling, and other resource management functions. Such a system may also provide automated networking of storage resources for storage capacity planning, management of storage performance, and reduced cost storage.

Although the present invention has been described in detail, it should be understood that various changes, substitutions and alterations can be made hereto without departing from the sphere and scope of the invention as defined by the appended claims. For example, elements and/or features of different illustrative embodiments may be combined with each other and/or substituted for each other within the scope of this disclosure and appended claims.

To aid the Patent Office, and any readers of any patent issued on this application in interpreting the claims appended hereto, applicants wish to note that they do not intend any of the appended claims to invoke ¶6 of 35 U.S.C. § 112 as it exists on the date of filing hereof unless “means for” or “step for” are used in the particular claim.

What is claimed is:

1. A method for managing backup information, comprising:
collecting backup information from a plurality of backup products;
converting the backup information collected from the plurality of backup products into a common format;
storing the collected backup information in a centralized catalog; and
providing access to the backup information stored in the centralized catalog.

2. The method of claim 1, wherein the backup information comprises backup media information.

3. The method of claim 1, wherein the backup information comprises information associated with a plurality of backup volumes.

4. The method of claim 1, wherein each backup product is associated with a disparate device within a computer network.

5. The method of claim 1, wherein each backup product is associated with a disparate device within a distributed system.

6. The method of claim 1, wherein each backup product comprises an application operable to obtain backup data stored on one or more data storage devices.

7. The method of claim 1, wherein collecting the backup information from the plurality of backup products comprises requesting the backup information from each of the plurality of backup products.

8. The method of claim 1, wherein collecting the backup information from the plurality of backup products comprises requesting the backup information from a plurality of catalogs, each catalog associated with a selected one of the backup products.

9. The method of claim 1, wherein the backup information is collected from the plurality of backup products at prescheduled intervals.

10. The method of claim 1, wherein collecting the backup information comprises:
receiving a list of a plurality of addresses, each address associated with one of the plurality of backup products; and
sending a request for the backup information to each of the plurality of backup products at the associated addresses; and
receiving the backup information from the plurality of backup products in response to sending the requests.

11. The method of claim 1, wherein collecting the backup information comprises:
discovering an address associated with each of the plurality of backup products;
sending a request for the backup information to each of the plurality of backup products at the associated addresses; and
receiving the backup information from the plurality of backup products in response to sending the requests.

12. The method of claim 1, wherein collecting the backup information comprises receiving backup information that is pushed up from the plurality of backup products.

13. The method of claim 12, wherein the backup information is received when a change in the backup information occurs.

14. The method of claim 1, further comprising interfacing the centralized catalog with a volume management interface operable to manage a plurality of volumes of backup information stored in the centralized catalog.

15. The method of claim 1, wherein the centralized catalog is associated with a mainframe computer.

16. A system for managing backup information, comprising:
a centralized database storing backup information associated with a plurality of backup products; and
a processor coupled to the centralized database and operable to:
collect backup information from a plurality of backup products;
convert the backup information collected from the plurality of backup products into a common format;
store the collected backup information in the centralized database; and
provide access to the backup information stored in the centralized database.

17. The system of claim 16, wherein the backup information comprises backup media information.

18. The system of claim 16, wherein the backup information comprises information associated with a plurality of backup volumes.

19. The system of claim 16, wherein each backup product is associated with a disparate device within a computer network.

20. The system of claim 16, wherein each backup product is associated with a disparate device within a distributed system.

21. The system of claim 16, wherein each backup product comprises an application operable to obtain backup data stored on one or more data storage devices.

22. The system of claim 16, wherein the processor is operable to collect the backup information from the plurality of backup products by requesting the backup information from each of the plurality of backup products.

23. The system of claim 16, wherein the processor is operable to collect the backup information from the plurality of backup products by requesting the backup information from a plurality of catalogs, each catalog associated with a selected one of the backup products.

24. The system of claim 16, wherein the backup information is collected from the plurality of backup products at prescheduled intervals.

25. The system of claim 16, wherein the processor is operable to collect the backup information by:
receiving a list of a plurality of addresses, each address associated with one of the plurality of backup products;
sending a request for the backup information to each of the plurality of backup products at the associated addresses; and
receiving the backup information from the plurality of backup products in response to sending the requests.

26. The system of claim 16, wherein the processor is operable to collect the backup information by:
discovering an address associated with each of the plurality of backup products;
sending a request for the backup information to each of the plurality of backup products at the associated addresses; and
receiving the backup information from the plurality of backup products in response to sending the requests.

27. The system of claim 16, wherein the processor is operable to collect the backup information by receiving backup information that is pushed up from the plurality of backup products.

28. The system of claim 27, wherein the backup information is received when a change in the backup information occurs.

29. The system of claim 16, further comprising a volume management interface operable to manage a plurality of volumes of backup information stored in the centralized catalog.

30. The system of claim 16, wherein the centralized catalog is associated with a mainframe computer.

31. Logic for managing backup information, the logic encoded in media and operable when executed to:
collect backup information from a plurality of backup products;
convert the backup information collected from the plurality of backup products into a common format;
store the collected backup information in a centralized database; and
provide access to the backup information stored in the centralized database.

32. The logic of claim 31, wherein the backup information comprises backup media information.

33. The logic of claim 31, wherein the backup information comprises information associated with a plurality of backup volumes.

34. The logic of claim 31, wherein each backup product is associated with a disparate device within a computer network.

35. The logic of claim 31, wherein each backup product is associated with a disparate device within a distributed system.

36. The logic of claim 31, wherein each backup product comprises an application operable to obtain backup data stored on one or more data storage devices.

37. The logic of claim 31, further operable when executed to collect the backup information from the plurality of backup products by requesting the backup information from each of the plurality of backup products.

38. The logic of claim 31, further operable when executed to collect the backup information from the plurality of backup products by requesting the backup information from a plurality of catalogs, each catalog associated with a selected one of the backup products.

39. The logic of claim 31, further operable when executed to collect the backup information from the plurality of backup products at prescheduled intervals.

40. The logic of claim 31, further operable when executed to collect the backup information by:
receiving a list of a plurality of addresses, each address associated with one of the plurality of backup products;
sending a request for the backup information to each of the plurality of backup products at the associated addresses; and
receiving the backup information from the plurality of backup products in response to sending the requests.

41. The logic of claim 31, further operable when executed to collect the backup information by:
discovering an address associated with each of the plurality of backup products;
sending a request for the backup information to each of the plurality of backup products at the associated addresses; and
receiving the backup information from the plurality of backup products in response to sending the requests.

42. The logic of claim 31, further operable when executed to collect the backup information by receiving backup information that is pushed up from the plurality of backup products.

43. The logic of claim 38, wherein the backup information is received when a change in the backup information occurs.

44. The logic of claim 31, further operable to interface the centralized catalog with a volume management interface operable to manage a plurality of volumes of backup information stored in the centralized catalog.

45. The logic of claim 31, wherein the centralized catalog is associated with a mainframe computer.
